(19) United States
(12) Patent Application Publication
(10) Pub. No.: US 2014/0086527 A1
(43) Pub. Date: Mar. 27, 2014

(54) VERTICAL LIGHT COUPLER

(71) Applicants: Ibrahim Ban, Beaverton, OR (US); Peter L. Chang, Portland, OR (US)

(72) Inventors: Ibrahim Ban, Beaverton, OR (US); Peter L. Chang, Portland, OR (US)

(21) Appl. No.: 13/629,355

(22) Filed: Sep. 27, 2012

(51) Int. Cl. G02B 6/32; B44C 1/22

(52) U.S. Cl. 385/33; 216/26

(57) ABSTRACT

An optical coupler includes a double-sided planar substrate having a lens manufactured on one side and a mode expander on the other side. The mode expander is coupled to a mirror that redirects light between the mode expander and the lens. The mirror is lithographically aligned with the lens. The substrate is optically transparent to a target wavelength to be used for optical signaling. The lens can be a lens array, in which case there can be a mirror for each lens in the array. The mode expander can couple an optical signal to a planar lightwave circuit (PLC) or other optical circuit. The lens on the optical coupler can interface with a single-mode optical fiber.

### FIELD

Embodiments of the invention are generally related to optical interconnects, and more particularly to a vertical coupler for optical interconnection.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2012, Intel Corporation, All Rights Reserved.

### BACKGROUND

The demand for computing devices continues to rise, even as the demand for computing devices to achieve higher performance also rises. However, conventional electrical I/O (input/output) signaling is not expected to keep pace with the demand for performance increases, especially for future high performance computing expectations. Currently, I/O signals are sent electrically to and from the processor through the board and out to peripheral devices. Electrical signals must pass through solder joints, traces, cables, and other electrical conductors. Electrical I/O signal rates are limited by the electrical characteristics of the electrical connectors.

While the use of optical interconnections finds increasing use in computing devices, currently the components used for optical signaling require special processing that increases the cost and complexity of system manufacturing. In one specific example, an electro-optic polymer (EOP) traditionally used in semiconductor optical circuits cannot withstand the temperatures associated with fabrication of a coupling circuit. Such processing warps or otherwise deforms the optical components of the circuit, which increases optical loss. Specifically with respect to the use of EOP, the thermal stresses can break the bonds of chromospheres, and negatively affect the orientation of chromospheres, which will result in reduced electro-optical effect. There may be EOPs of higher-temperature tolerant materials, but such materials would have to be developed. Assuming such materials were made, they would be expected to require increased cost and complexity of manufacturing.

Additionally, optical loss occurs when the alignment of optical circuits is outside of fairly precise alignment tolerances. The traditional alignment of optical interconnections has been through mechanical alignment means. It is costly and difficult to achieve the desired optical tolerances via mechanical alignment means.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with a vertical light coupler including a lens on one side and a mode expander on the other.

FIG. 2 is a block diagram of an embodiment of a system with a vertical light coupler that redirects light between a lens and a mode expander on opposite sides of a substrate.

FIG. 3 is a block diagram of an embodiment of a system with a vertical light coupler including a processing artifact adjacent a mirror on a substrate.

FIGS. 4A-4D are block diagrams illustrating an embodiment of processing a lens on one side of a substrate and a mode expander on the other.

FIGS. 5A-5E are block diagrams illustrating another embodiment of processing a lens on one side of a substrate and a mode expander on the other.

FIG. 6 is a flow diagram of an embodiment of a process for processing a lens on one side of a substrate and a mode expander on the other.

FIG. 7 is a block diagram of an embodiment of a computing system in which a vertical light coupler can be implemented.

FIG. 8 is a block diagram of an embodiment of a mobile device in which a vertical light coupler can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, an optical coupler includes a double-sided planar substrate having a lens manufactured on one side and a mode expander on the other side. The mode expander is coupled to a mirror that redirects light between the mode expander and the lens. The lens is processed directly into the substrate via lithographic processing techniques. The mode expander and mirror are processed onto the substrate via lithographic processing techniques. Thus, the mirror is lithographically aligned with the lens. The substrate is optically transparent to a target wavelength to be used for optical signaling, and the optical signal traverses the substrate between the lens and the mirror. The lens can be a lens array, in which case there can be a mirror for each lens in the array. The mode expander can couple an optical signal to a planar lightwave circuit (PLC) or other optical circuit (e.g., silicon photonics circuits). The alignment tolerances are tight enough to enable the lens on the optical coupler to interface with a single-mode optical fiber.

The processing of the lens on one side of the substrate, and the mode expander and mirror on the other side of the substrate allows for the separation of high temperature processing from other processing that does not need such high temperatures. Thus, for example, a high temperature processing of the mode expander onto the substrate can occur first, and the substrate with mode expander can later be bonded to an optical circuit. Thus, the optical circuit is not exposed to the high temperature processing, and EOP (electro-optic polymer) used in the optical circuit does not require high temperature tolerance. Additionally, processing the mode expander and lens on the substrate separately from the optical circuit decouples optical circuit yield problems from processing issues related to placement and alignment of the optical coupler.

As mentioned above, the coupler, which can be referred to as a vertical light coupler (VLC), provides an interface between an optical circuit and an optical fiber connector. The optical circuit can be a PLC. The tolerance of the alignment between the mode expander and the waveguide(s) on the optical circuit is not as tight as the tolerance of alignment between the mirror coupled to the mode expander and the lens. In one embodiment, there needs to be a 1 um alignment between the mirror and the lens. Lithographic processing techniques can achieve such an alignment tolerance easier than mechanical alignment means.

The optical coupler described herein is fabricated with lens on one side of a substrate and a mode expander and mirror on the other side. In one embodiment, the lens is a lens array and there are corresponding multiple mirrors. For transmitted optical signals, light guided through the mode expander is internally reflected by the mirror (i.e., total internal reflection), travels through the substrate, and is collimated by the lens (meaning the photons are aligned in parallel). For received optical signals, light received at the lens is focused through the substrate (meaning the photons are redirected to intersect), internally reflected by the mirror, and guided through the mode expander to the optical circuit.

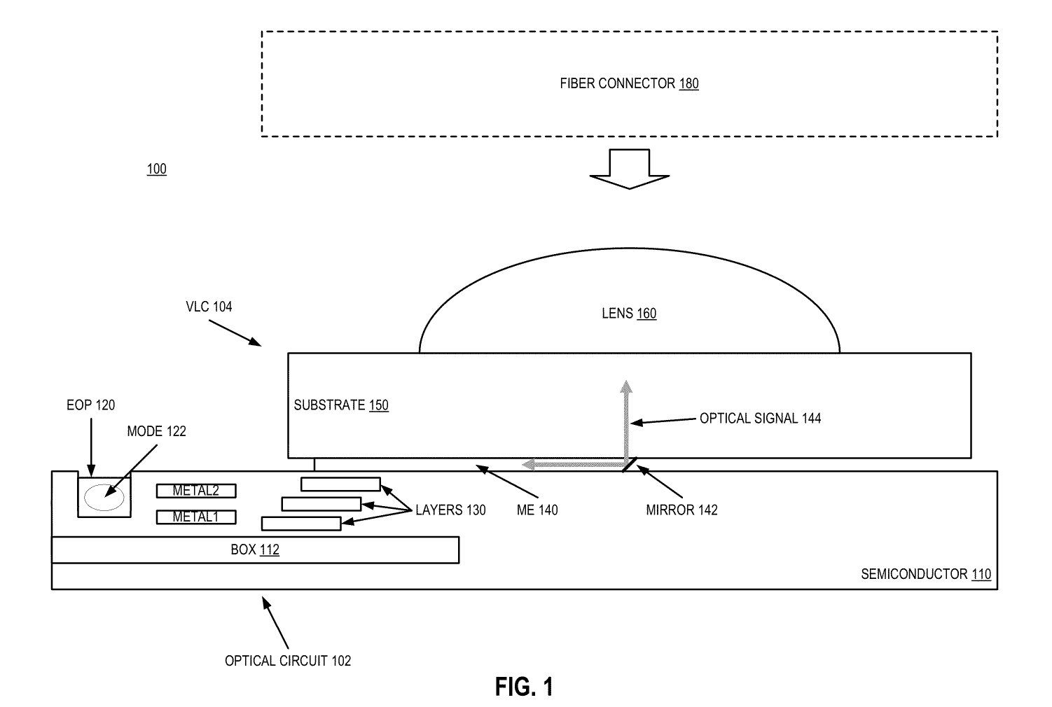

FIG. 1 is a block diagram of an embodiment of a system with a vertical light coupler including a lens on one side and a mode expander on the other. System 100 includes optical circuit 102 coupled to coupler 104 (which can also be referred to as an optical connector). Coupler 104 includes mode expander (ME) 140 manufactured on substrate 150. It will be understood that certain elements are shown from a cross-section view, and the components are not necessarily to scale.

Optical circuit 102 is manufactured on semiconductor substrate 110. Semiconductor 110 can be, for example, a silicon substrate. In one embodiment, one or more optical circuits are manufactured with SOI (silicon on insulator) techniques. In one embodiment, the insulator is a buried oxide layer (BOX) 112. In one embodiment, optical circuit 102 includes EOP 120 that is used to manufacture a modulator in semiconductor 110. The modulator puts a data signal on optical mode 122 generated by an optical source (e.g., laser). The optical circuit commonly includes one or more metal layers (shown by Metal1 and Metal2), which are laid as part of the lithographic processing of the optical circuit.

Layers 130 couple the optical signal from the optical circuitry to ME 140. In a silicon-based optical circuit, layer 130 can be, for example, silicon nitride (SiN) layers. Semiconductor 110 includes waveguides to couple to ME 140. The waveguides can include layers 130 or layers 130 can couple light to the waveguides.

VLC 104 represents a coupler in accordance with any embodiment described herein. The coupler includes substrate 150, on which lens 160 is processed. The lens can be formed on substrate 150 by etching into the substrate (e.g., using pattern transfer), by means of polymer reflow, or by other means. Substrate 150 can also include alignment marks and/or support structures (not illustrated). VLC 104 connects to fiber connector 180, which includes a fiber corresponding to lens 160. In an embodiment where lens 160 represents a lens array (e.g., a row of lenses or multiple rows of lenses), fiber connector 180 will generally include an optical fiber corresponding to each lens. Fiber connector 180 can also include a lens to couple to lens 160, which lens in fiber connector 180 then interfaces with an optical fiber.

Optical signal 144 represents an optical signal exchanged between lens 160 and ME 140 to couple to optical circuit 104 (e.g., a PLC). Mirror 142 redirects optical signal 144 between lens 160 and ME 140. While the drawing of system 100 is generally not intended to be to scale, the sizing of mirror 142 compared to the sizing of lens 160 in the drawing is intended to show one embodiment of relative size of these elements. For example, in one embodiment, mirror 142 can have a height of approximately 5 um, while lens 160 has a width of somewhere around 100-150 um. Given the relative size of the mirror compared to lens 160, it will be understood why the alignment of the mirror to the lens has a very tight tolerance. In contrast, the alignment tolerance between ME 140 and the waveguides of optical circuit 102 is not required to be as tightly controlled.

In one embodiment, substrate 150 is a glass substrate, and lens 160 is processed by removing glass to form the lens. Substrate 150 can be any material transparent to the target wavelength, and allows for the processing described herein. Glass has high reflection and is transparent to wavelengths associated with optical signaling. Other materials include appropriate crystalline inorganic materials and/or amorphous plastic structures having sufficient optical clarity at the wavelengths of interest. It will be understood that amorphous materials can be molded, whereas crystalline materials would need to be manufactured using other techniques. The wavelengths are specific to the design, and in particular the light source (e.g., laser) used.

Optical signal 144 does not need a specific waveguide through substrate 150 because of the collimating and focusing of the light provided by lens 160. It will be understood that the thickness of substrate 150 is not to scale. For received signals, mirror 142 can be placed at the point of focus of lens 160. For transmit signals, optical signal 144 will spread somewhat through substrate 150, but is then collimated by lens 160 for transmission to fiber connector 180. The size and shape of lens 160 can be modified to match the lens on to the end of the fiber, and match the spreading of light from the fiber to be encompassed and collimated by the lens. The same lens array can include transmit and receive lenses, which can be shaped and/or sized differently consistent with their respective functions (i.e., transmit or receive).

In one embodiment, ME 140 is a separate element that is processed onto substrate 150 via a thermal anneal. For example, ME 140 can be first formed as a separate element via lithographic processing. In one embodiment, the thermal anneal operates to set the structure of ME 140, for example, by forming new bonds as in a thermoset polymer. The thermal anneal can also operate to fuse the material of ME 140 to the material of substrate 150. However, the thermal anneal can take two hours of high temperature exposure to complete. Thus, by separating the processing of ME 140 onto substrate 150 to occur prior to the bonding of VLC 104 onto semiconductor 110. Additionally, the processing of ME 140 can include the processing of mirror 142, including alignment of mirror 142 to lens 160.

In one embodiment, fiber connector 180 includes multimode fiber (MMF). Typically, commercial couplers use MMF connections. In one embodiment, fiber connector 180 includes single-mode fiber (SMF). SMF alignment requires a tighter alignment. There is roughly a 50 μm core for MMF, with an alignment tolerance of approximately 15 μm pending the optical design. The core size for SMF is 8 μm with an alignment tolerance of approximately 1 μm. The tighter tolerances are achievable with the coupler disclosed herein, processed in accordance with any embodiment described.

Mirror 142 is coupled to ME 140. In one embodiment, mirror 142 is a processed edge of ME 142, such as an etched (e.g., pattern transfer) or ablated area in the material of ME 140. Mirror 142 could optionally be processed with metallization for increased reflectivity, via grayscale processing, or other means. However, mirror 142 can operate as a TIR (total internal reflection) surface simply by virtue of the index contrast between the component material of ME 140 and the surrounding material (e.g., glass or semiconductor to air) as well as reflection off a metalized mirror surface.

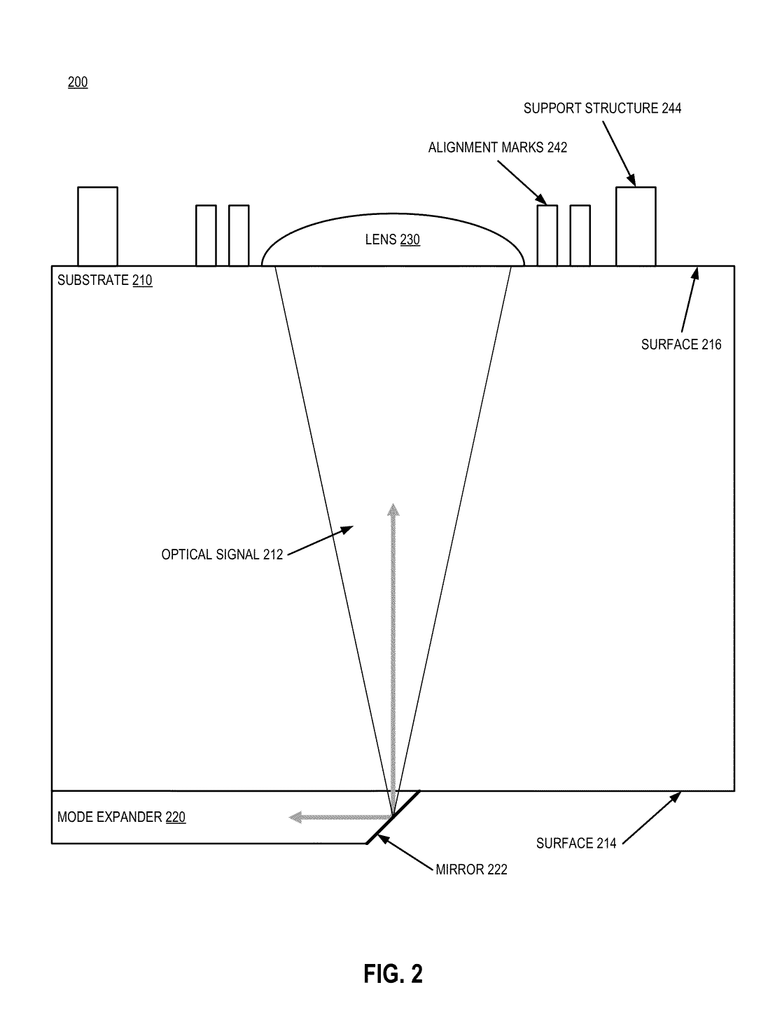

FIG. 2 is a block diagram of an embodiment of a system with a vertical light coupler that redirects light between a lens and a mode expander on opposite sides of a substrate. Coupler 200 can be one example of VLC 102 of FIG. 1. Coupler 200 includes substrate 210, which includes a lens or lens array 230 processed on a side of the coupler that will interface with an optical connector. Substrate 210 further includes mode expander 220 processed on the other side of the coupler, a side that will interface with the optical circuit. It is understood that technically substrate 210 can include more “sides” than those referred to. For purposes of clarity, it will be understood that reference to a “side” of the substrate refers to one of two opposing planar surfaces of the substrate. The planar surfaces are parallel or substantially parallel. Typically the surface area of the planar surfaces is larger than any other planar surface area that might exist in substrate 210. Additionally, it will be understood that the etching and/or other processing of materials onto the surfaces is not understood to destroy the parallelism of the surfaces.

Thus, substrate 210 includes surface 214 that will interface with the optical circuit, and includes ME 220 processed on it. Substrate 210 further includes surface 216 that will interface with an optical fiber connector, and includes lens 230 processed on it. In one embodiment, surface 216 includes alignment marks 242 processed on it and/or one or more support structures 244 (or a single structure or mark that loops around the lens or lens array). Support structure 244 and alignment marks 242 can provide alignment for double-sided processing of substrate 210, and/or for interconnection purposes with an interfacing fiber connector. Kinematic alignment structures can also be processed on substrate 210 for aligning fiber connector (not shown) and VLC 200.

In one embodiment, lens 230 is fabricated on surface 216 via grayscale lithographic processing and etching of the glass. Such techniques are known and will not be discussed in detail herein. ME 220 and mirror 222 are fabricated on surface 214, and mirror 222 is aligned via lithographic processing techniques. In one embodiment, surface 214 includes alignment marks, kinematic alignment structures, and/or support structures to facilitate processing.

While system 100 illustrated a relative comparison of size of the mirror to the lens, coupler 200 illustrates a relative size of lens 230 to the thickness of substrate 210. Namely, in one embodiment, lens 230 is roughly 100-150 um in diameter, and substrate 210 is approximately 250-300 um from surface 214 to surface 216. Optical signal 212 is reflected by mirror 222 and exchanged through substrate 210 with lens 230. For received signals, lens 230 focuses the light as shown to mirror 222. For transmitted signals, optical signal spreads between mirror 222 and lens 230, but is then collimated by lens 230 for transmission to an optical fiber.

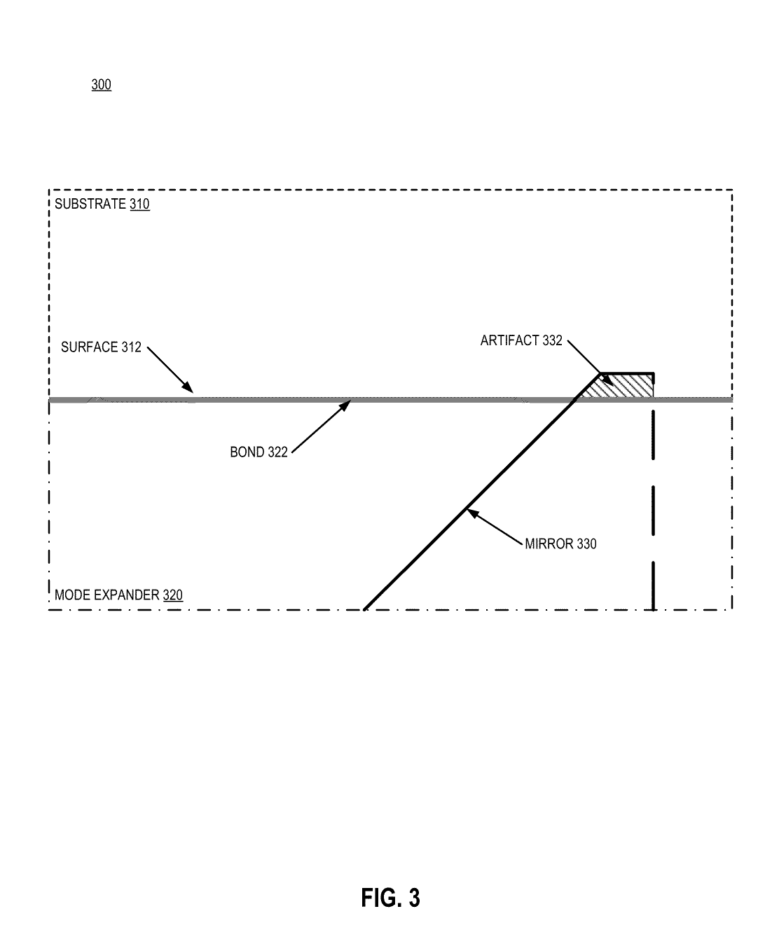

FIG. 3 is a block diagram of an embodiment of a system with a vertical light coupler including a processing artifact adjacent a mirror on a substrate. Coupler 300 illustrates only a portion of the coupler. Coupler 300 can be a coupler in accordance with any embodiment described herein. Specifically illustrated is the interface of mode expander 320 and substrate 310 near mirror 330. The drawing is not to scale.

Bond 322 represents a bonding of ME 320 to substrate 310. Bond 322 can occur, for example, via thermal anneal, where the material of ME 320 is fused to the material of substrate 310. Bond 322 can alternatively be formed by other means, such as through the use of a bonding material. The bonding can be a by-product of a thermal anneal process used to give a permanent shape and structure to ME 320. Bond 322 occurs at surface 312 of substrate 310, and in one embodiment can include a mixing of material in the bonding region illustrated by the shaded area. The shaded area is not necessarily to scale, and the mixing of material can be thicker or thinner than shown relative to the size of mirror 330. The mixing of material may not occur at all, depending on how the bond between the surfaces is created.

Mirror 330 can be processed onto mode expander 320 via any of a number of processing techniques, such as lithographic processing and etching (e.g., pattern transfer), grayscale processing, laser ablation, and/or other means. Processing techniques are imperfect and tend to leave “artifacts” of the processing. Processing artifacts can include evidence of over-etching or over-ablation. Artifact 332 illustrates such a processing artifact.

The size of artifact 332 is not necessarily to scale. In one embodiment, artifact 332 only extends into the shaded region of bond 322. In one embodiment, artifact 332 can extend beyond the area of mixing of materials into the original material of substrate 310 (as shown). The artifacts that are left from processing the mirror will generally be adjacent the mirror. Artifact 332 can be said to cause a region of different thickness. Thus, the thickness of bond 322 can be said to be thicker where the artifact is not, and thinner where the artifact is. Additionally, artifact 332 can be said to extend into substrate 310, whether into the original substrate material itself or into the bonding material. Whether into the original substrate material or the mixed material, in one embodiment the artifact can be said to extend into surface 312. In one embodiment, artifact 332 is a cavity into surface 312 or a cavity in the planar substrate adjacent the mirror.

While other illustrations herein of the mode expander show the mode expander ending at the mirror, it will be understood that the mode expander can be a sheet of material, and mirror 330 can be processed into the material. Thus, some of the material will be removed in a particular area, for a width (e.g., the width of a lens, or the entire width of a lens array), or some other configuration. Therefore, the material from which ME 320 is processed can extend beyond the other side of mirror 330. However, the mode expander itself may be considered only the material up to the interface with the mirror.

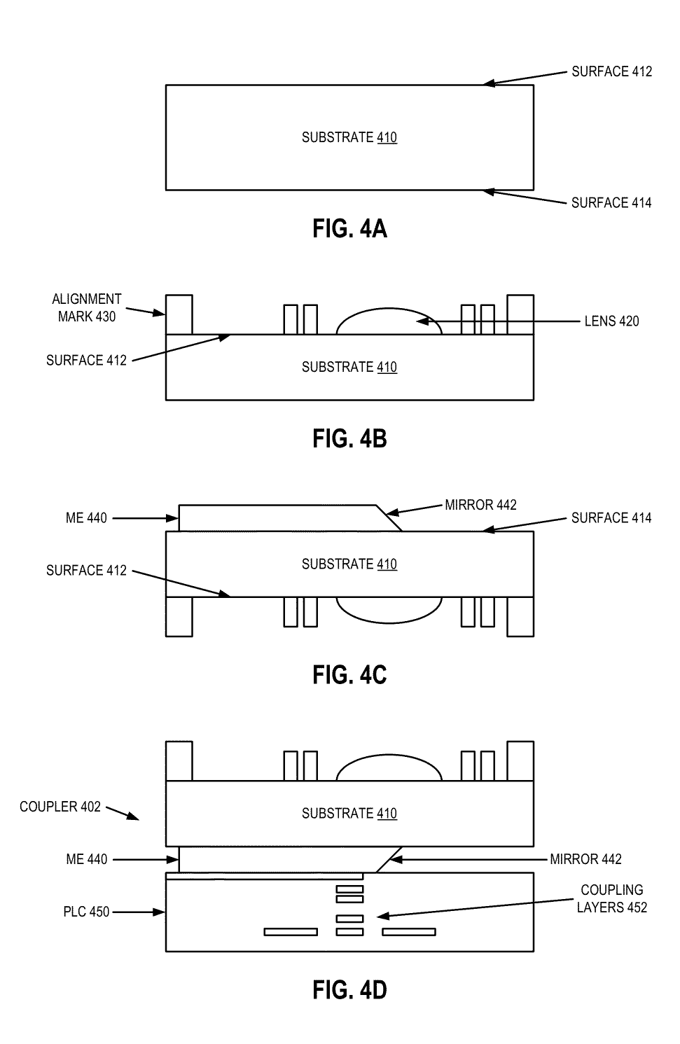

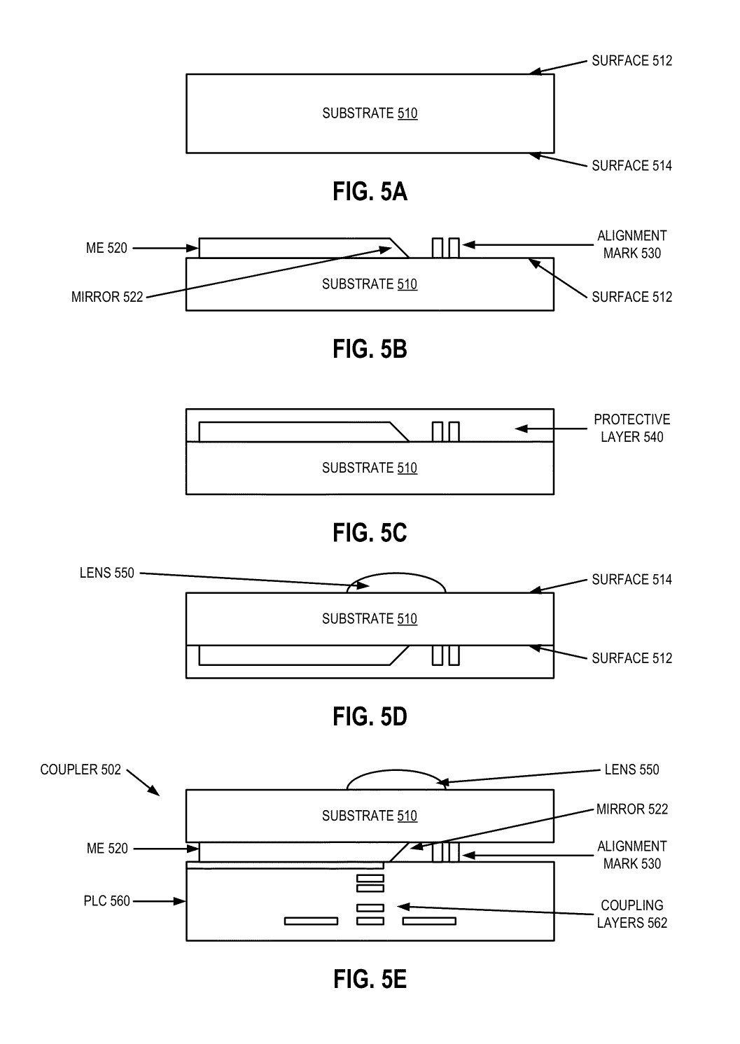

FIGS. 4A-4D are block diagrams illustrating of an embodiment of processing a lens on one side of a substrate and a mode expander on the other. The coupler described with reference to FIGS. 4A-4D represents an embodiment of a coupler in accordance with any embodiment described herein, except that of FIGS. 5A-5E. Referring to FIG. 4A, substrate 410 includes surfaces 412 and 414. Both surfaces are prepared for processing. Referring to FIG. 4B, surface 412 of substrate 410 is processed. It will be understood that in one embodiment surface 414 could be processed first, and surface 412 be processed after. Material can be removed from surface 412 to lower the surface, and form lens 420 on the surface. Alternatively, lens 420 could be formed by building material onto surface 412, and substrate 410 may or may not be thinned. It will be understood that the surface labeled as 412 in FIG. 4B could be relabeled 412′, seeing that the surface is modified by the processing of the lens onto the surface. In one embodiment, alignment marks, kinematic alignment structures, and/or support structures 430 can be processed on surface 412 as well. In one embodiment, the alignment features are processed in conjunction with the processing of lens 420.

Referring to FIG. 4C, substrate 410 is flipped to expose surface 414 to the processing equipment. Then ME 440 can be fabricated on surface 414. Mirror 442 is also fabricated on surface 414, coupled to ME 440 to enable mirror 442 to exchange optical signals between lens 420 and ME 440. Mirror 442 can be patterned by various techniques mentioned above. In one embodiment, mirror metallization is not needed when cladding is not used and an adhesive is restricted to the perimeter of the structures. The adhesive is an adhesive to bond ME 440 to PLC 450 as shown in FIG. 4D below. If the adhesive is only used at the perimeters of ME 440, then no adhesive will migrate onto mirror surface 442. If the adhesive does migrate onto the mirror surface, it may cause optical loss or reduction in the electro-optical effect. However, metallization can be eliminated depending on the material from which ME 440 and/or the material of mirror 442 is fabricated. For example, some materials form total internal reflection surfaces at 45 degrees in air, and would not need metallization if an air gap remained on the other side of the mirror surface.

Referring to FIG. 4D, coupler 402 is shown coupled to PLC 450. Coupler 402 and ME 440 are bonded to PLC 450. Coupling layers 452 couple the generated optical signal to ME 440, which is then reflected off mirror 442 to lens 420 for transmitted signals. For received signals, lens 420 receives a signal, which is then reflected by mirror 442 to ME 440, and coupled down to a photoreceptor on PLC 450.

FIGS. 5A-5E are block diagrams illustrating another embodiment of processing a lens on one side of a substrate and a mode expander on the other. The coupler described with reference to FIGS. 5A-5E represents an embodiment of a coupler in accordance with any embodiment described herein, except that of FIGS. 4A-4D. Referring to FIG. 5A, substrate 510 includes surfaces 512 and 514. Both surfaces are prepared for processing. In one embodiment, substrate 510 is formed of a glass or crystalline material. In one embodiment, substrate 510 is a single-crystalline material such as silicon (Si) or gallium-arsenide (GaAs). The use of such a single-crystalline material can provide the ability to form atomically controllable 45-degree surfaces by means of wet orientation etch chemistries (e.g., KOH, TMAH). The ability to generate controllable 45-degree surfaces can require design and/or process changes to facilitate the formation of a mode expander and/or a mirror, and/or the formation of kinematic alignment features.

Referring to FIG. 5B, surface 512 of substrate 510 is processed. It will be understood that the orientation of surfaces 512 and 514 can be considered subjective, in which case either side could be processed first, and either side could be used to process the lens or the mode expander. Alternatively, at least one side of substrate 510 can be provided with alignment features. Material can be removed from at least one surface to thin substrate 510. In one embodiment, substrate 510 is not thinned any more than removing material for purposes of etching.

ME 520 can be fabricated on surface 512. Mirror 522 is also fabricated on surface 512, coupled to ME 520 to enable mirror 522 to exchange optical signals between a lens and ME 520. Mirror 522 can be patterned by various techniques mentioned above, including those described with respect to FIGS. 4A-4D. In one embodiment, ME 520 is adhered to substrate 510 via the use of adhesive to bond a separate structure to the substrate as the ME. In an alternative embodiment, ME is formed from the bulk material of substrate 510. In another alternate embodiment, material (e.g., polymer) is deposited or reflowed onto substrate 510 to form ME 520.

In one embodiment, alignment mark(s) 530 are formed on substrate 510. In an alternative embodiment, alignment marks are already formed in substrate 510 via some process prior to the processing of the ME and lens on the substrate. In one embodiment, alignment feature 530 is formed at the same time that ME 520 is processed onto substrate 510. In another embodiment, alignment mark 530 is formed as a separate operation from processing ME 520. Alignment mark 530 can be etched into one or both sides of substrate 510 (either prior to processing the lens and ME, or as part of processing the lens and ME).

Referring to FIG. 5C, in one embodiment, protective layer 540 is formed on substrate 510 over coupler 502 and alignment mark 530. Protective layer 540 could be, for example, a protective resist layer. Referring to FIG. 5D, substrate 510 is flipped, and lens 550 is processed onto surface 514. Lens 550 could be formed via any known process, such as those discussed above with respect to FIGS. 4A-4D. In one embodiment, lens 550 is formed from polymer materials deposited or reflowed onto surface 514.

Referring to FIG. 5E, coupler 502 is shown coupled to PLC 560. Coupler 502 and ME 520 are bonded to PLC 560. Coupling layers 562 couple the generated optical signal to ME 520, which is then reflected off mirror 522 to lens 550 for transmitted signals. For received signals, lens 550 receives a signal, which is then reflected by mirror 522 to ME 520, and coupled down to a photoreceptor on PLC 560. Alignment mark 530 can assist in lithographically aligning the substrate for coupling to PLC 560.

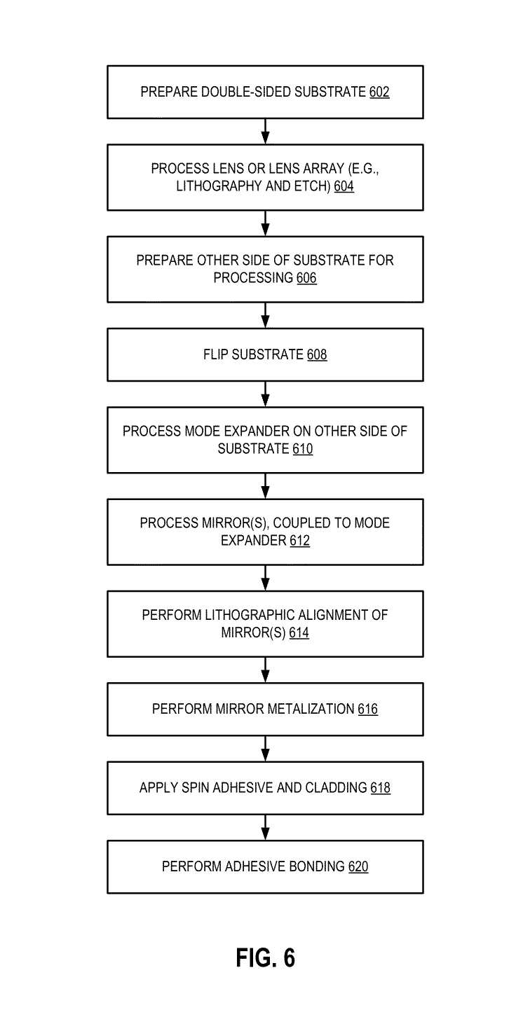

FIG. 6 is a flow diagram of an embodiment of a process for processing a lens on one side of a substrate and a mode expander on the other. In one embodiment processing equipment prepares a double sided substrate, 602. In an alternative embodiment, the processing equipment can receive a prepared substrate. The processing equipment can process a lens or lens array, for example, via lithography and etching, 604. During the processing of the lens side of the substrate, material may end up on the other surface of the substrate. Thus, the processing equipment can prepare the other side of the substrate for processing, 606, such as by cleaning it, and/or adding alignment features.

The processing equipment flips the substrate to expose the other side for processing by the equipment, 608, and the processing equipment processes a mode expander on the side of the substrate opposite the lens, 610. The processing of the mode expander can include a thermal cure to set the permanent shape of the mode expander, such as by forming new bonds (e.g., in thermoset polymers). It will be understood that the thermal cure can also act to bond the mode expander to the substrate. In one embodiment, such a thermal can include “baking” the assembly for approximately 2 hours at approximately 250 C. Other times and temperatures are possible, especially depending on the materials used for the substrate and the mode expander.

In one embodiment, the processing equipment processes one or more mirrors on the side of the substrate with the mode expander, coupled to the mode expander, 612. In one embodiment, the mirrors are part of the mode expander. The processing equipment performs lithographic operations to align the mirror, 614. The lithographic processing operations can occur as part of fabricating the mode expander and/or the fabrication of the mirror. In one embodiment, the processing of the mirror can include grayscale lithography, laser ablation, and/or etching. The lithography and etching can be performed to expose the mirrors for optional mirror metallization, 616. In one embodiment, the processing equipment applies a spin adhesive and optional cladding, 618. The processing equipment (or packaging equipment as opposed to processing equipment) performs adhesive bonding of the mode expander and coupler to an optical circuit, 620.

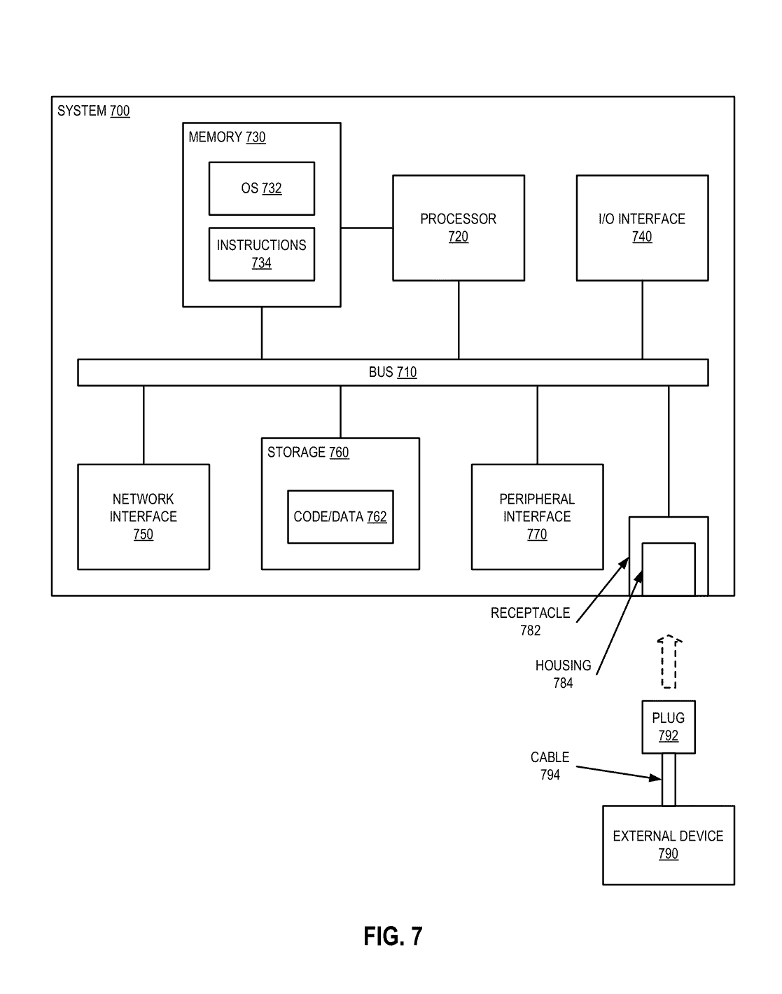

FIG. 7 is a block diagram of an embodiment of a computing system in which a vertical light coupler can be implemented. System 700 represents a computing device in accordance with any embodiment described herein, and can be a laptop computer, a desktop computer, a server, a gaming or entertainment control system, a scanner, copier, printer, or other electronic device. System 700 includes processor 720, which provides processing, operation management, and execution of instructions for system 700. Processor 720 can include any type of microprocessor, central processing unit (CPU), processing core, or other processing hardware to provide processing for system 700. Processor 720 controls the overall operation of system 700, and can be include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 730 represents the main memory of system 700, and provides temporary storage for code to be executed by processor 720, or data values to be used in executing a routine. Memory 730 can include one or more memory devices such as read-only memory (ROM), flash memory, one or more varieties of random access memory (RAM), or other memory devices, or a combination of such devices. Memory 730 stores and hosts, among other things, operating system (OS) 732 to provide a software platform for execution of instructions in system 700. Additionally, other instructions 734 are stored and executed from memory 730 to provide the logic and the processing of system 700. OS 732 and instructions 734 are executed by processor 720.

Processor 720 and memory 730 are coupled to bus/bus system 710. Bus 710 is an abstraction that represents any one or more separate physical buses, communication lines/interfaces, and/or point-to-point connections, connected by appropriate bridges, adapters, and/or controllers. Therefore, bus 710 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 710 can also correspond to interfaces in network interface 750.

System 700 also includes one or more input/output (I/O) interface(s) 740, network interface 750, one or more internal mass storage device(s) 760, and peripheral interface 770 coupled to bus 710. I/O interface 740 can include one or more interface components through which a user interacts with system 700 (e.g., video, audio, and/or alphanumeric interfacing). Network interface 750 provides system 700 the ability to communicate with remote devices (e.g., servers, other computing devices) over one or more networks. Network interface 750 can include an Ethernet adapter, wireless interconnection components, USB (universal serial bus), or other wired or wireless standards-based or proprietary interfaces.

Storage 760 can be or include any conventional medium for storing large amounts of data in a nonvolatile manner, such as one or more magnetic, solid state, or optical based disks, or a combination. Storage 760 hold code or instructions and data 762 in a persistent state (i.e., the value is retained despite interruption of power to system 700). Storage 760 can be generically considered to be a “memory,” although memory 730 is the executing or operating memory to provide instructions to processor 720. Whereas storage 760 is nonvolatile, memory 730 can include volatile memory (i.e., the value or state of the data is indeterminate if power is interrupted to system 700).

Peripheral interface 770 can include any hardware interface not specifically mentioned above. Peripherals refer generally to devices that connect dependently to system 700. A dependent connection is one where system 700 provides the software and/or hardware platform on which operation executes, and with which a user interacts.

In one embodiment, system 700 can include one or more receptacles 782 with housing 784 to receive plug 792 or mate with plug 792 to connect to external device 790. Receptacle 782 includes housing 784, which provides the mechanical connection mechanisms. As used herein, mating one connector with another refers to providing a mechanical connection. The mating of one connector with another typically also provides a communication connection. Receptacle 782 can connect directly to one or more buses of bus system 710, or receptacle 782 can be associated directly with one or more devices, such as network interface 750, I/O interface 740, storage 760, peripheral interface 770, or processor 720.

Plug 792 is a connector plug that allows external device 790 (which can be any of the same types of devices discussed above) to interconnect with device 700. In one embodiment, external device 790 can be a router or switch device. Plug 792 can be directly built into external device 790 (with or without a cord or cable 794), or can be interconnected to external device 790 via a standalone cable 794. In one embodiment, plug 792 supports communication via an optical interface or both an optical interface and an electrical interface. The interconnection of receptacle 782 to bus 710 can similarly include an optical path or both an optical and electrical signal path. Receptacle 782 can also include an optical communication connection that is converted to an electrical signal prior to being placed on bus 710.

In one embodiment, one or more components of system 700 include an optical interface that uses a vertical light coupler in accordance with any embodiment described herein. The coupler allows the use of a low-profile optical interface that does not impose thermal stress on the components of the optical circuit. The optical components can interface with one or more other components internally to system 700, and/or with one or more external devices 790 via receptacle(s) 782. Receptacle 782 provides the hardware port through which external optical signals can be exchanged, for example, with peripheral devices.

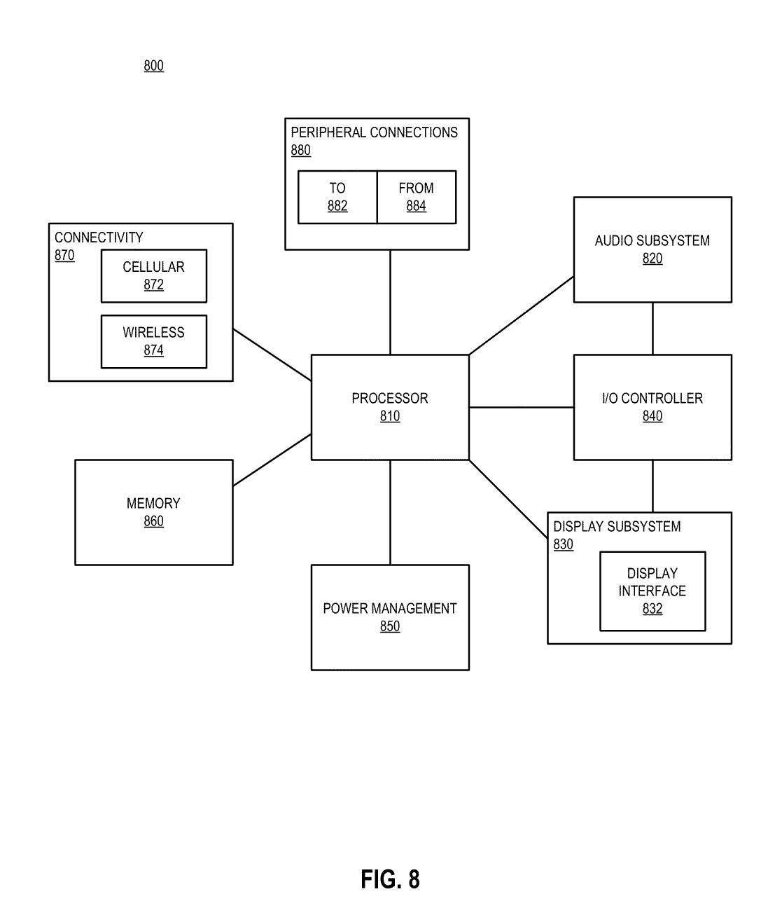

FIG. 8 is a block diagram of an embodiment of a mobile device in which a vertical light coupler can be implemented. Device 800 represents a mobile computing device, such as a computing tablet, a mobile phone or smartphone, a wireless-enabled e-reader, or other mobile device. It will be understood that certain of the components are shown generally, and not all components of such a device are shown in device 800.

Device 800 includes processor 810, which performs the primary processing operations of device 800. Processor 810 can include one or more physical devices, such as microprocessors, application processors, microcontrollers, programmable logic devices, or other processing means. The processing operations performed by processor 810 include the execution of an operating platform or operating system on which applications and/or device functions are executed. The processing operations include operations related to I/O (input/output) with a human user or with other devices, operations related to power management, and/or operations related to connecting device 800 to another device. The processing operations can also include operations related to audio I/O and/or display I/O.

In one embodiment, device 800 includes audio subsystem 820, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 800, or connected to device 800. In one embodiment, a user interacts with device 800 by providing audio commands that are received and processed by processor 810.

Display subsystem 830 represents hardware (e.g., display devices) and software (e.g., drivers) components that provide a visual and/or tactile display for a user to interact with the computing device. Display subsystem 830 includes display interface 832, which includes the particular screen or hardware device used to provide a display to a user. In one embodiment, display interface 832 includes logic separate from processor 812 to perform at least some processing related to the display. In one embodiment, display subsystem 830 includes a touchscreen device that provides both output and input to a user.

I/O controller 840 represents hardware devices and software components related to interaction with a user. I/O controller 840 can operate to manage hardware that is part of audio subsystem 820 and/or display subsystem 830. Additionally, I/O controller 840 illustrates a connection point for additional devices that connect to device 800 through which a user might interact with the system. For example, devices that can be attached to device 800 might include microphone devices, speaker or stereo systems, video systems or other display device, keyboard or keypad devices, or other I/O devices for use with specific applications such as card readers or other devices.

As mentioned above, I/O controller 840 can interact with audio subsystem 820 and/or display subsystem 830. For example, input through a microphone or other audio device can provide input or commands for one or more applications or functions of device 800. Additionally, audio output can be provided instead of or in addition to display output. In another example, if display subsystem includes a touchscreen, the display device also acts as an input device, which can be at least partially managed by I/O controller 840. There can also be additional buttons or switches on device 800 to provide I/O functions managed by I/O controller 840.

In one embodiment, I/O controller 840 manages devices such as accelerometers, cameras, light sensors or other environmental sensors, gyroscopes, global positioning system (GPS), or other hardware that can be included in device 800. The input can be part of direct user interaction, as well as providing environmental input to the system to influence its operations (such as filtering for noise, adjusting displays for brightness detection, applying a flash for a camera, or other features).

In one embodiment, device 800 includes power management 850 that manages battery power usage, charging of the battery, and features related to power saving operation. Memory subsystem 860 includes memory device(s) for storing information in device 800. Memory 860 can include nonvolatile (state does not change if power to the memory device is interrupted) and/or volatile (state is indeterminate if power to the memory device is interrupted) memory devices. Memory 860 can store application data, user data, music, photos, documents, or other data, as well as system data (whether long-term or temporary) related to the execution of the applications and functions of system 800.

Connectivity 870 includes hardware devices (e.g., wireless and/or wired connectors and communication hardware) and software components (e.g., drivers, protocol stacks) to enable device 800 to communicate with external devices. The device could be separate devices, such as other computing devices, wireless access points or base stations, as well as peripherals such as headsets, printers, or other devices.

Connectivity 870 can include multiple different types of connectivity. To generalize, device 800 is illustrated with cellular connectivity 872 and wireless connectivity 874. Cellular connectivity 872 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 874 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication (including optical communication) occurs through a solid communication medium.

Peripheral connections 880 include hardware interfaces and connectors, as well as software components (e.g., drivers, protocol stacks) to make peripheral connections. It will be understood that device 800 could both be a peripheral device (“to” 882) to other computing devices, as well as have peripheral devices (“from” 884) connected to it. Device 800 commonly has a “docking” connector to connect to other computing devices for purposes such as managing (e.g., downloading and/or uploading, changing, synchronizing) content on device 800. Additionally, a docking connector can allow device 800 to connect to certain peripherals that allow device 800 to control content output, for example, to audiovisual or other systems.

In addition to a proprietary docking connector or other proprietary connection hardware, device 800 can make peripheral connections 880 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

Any of the I/O interconnections can be performed optically. Thus, I/O controller 840, display subsystem 830, memory 860, connectivity 870, and/or peripheral connections 880 can have an optical connection including a vertical light in accordance with any embodiment described herein. The coupler allows the use of a low-profile optical interface that does not impose thermal stress on the components of the optical circuit.

In one aspect, an optical connector includes a planar substrate having two planar surfaces, one on each opposing side of the substrate, the substrate transparent to a target wavelength, a lens processed on one of the planar surfaces of the substrate, a mode expander processed on the other planar surface of the substrate, and a mirror coupled to the mode expander, the mirror lithographically aligned with the lens to exchange an optical signal of the target wavelength between the mode expander and the lens.

In one embodiment, the planar substrate comprises a glass substrate prepared for processing on both sides of the glass. In one embodiment, the planar surface to which the mode expander is processed includes a processing artifact cavity in the planar substrate adjacent the mirror. In one embodiment, the mode expander is to interface optical signals between the lens and a waveguide of an optical circuit. In one embodiment, the mirror comprises a total internal reflection surface processed in the mode expander. In one embodiment, the total internal reflection surface is processed on the mode expander via laser ablation. In one embodiment, the total internal reflection surface is processed on the mode expander via grayscale processing. In one embodiment, the optical connector further includes alignment marks processed on a planar surface of the substrate, the alignment marks including structures extending from the planar surface for alignment of the optical connector. In one embodiment, the optical connector further includes kinematic alignment structures processed on a planar surface of the substrate.

In one aspects, an optical circuit includes an optical coupler having a planar substrate having two planar surfaces, one on each opposing side of the substrate, the substrate transparent to a target wavelength; a lens processed on one of the planar surfaces of the substrate; a mode expander processed on the other planar surface of the substrate; and a mirror coupled to the mode expander, the mirror lithographically aligned with the lens to exchange an optical signal of the target wavelength between the mode expander and the lens; and a planar lightwave circuit (PLC) coupled to the mode expander to exchange optical signals between the lens and an optical processing circuit.

In one embodiment, the planar substrate comprises a glass substrate prepared for processing on both sides of the glass. In one embodiment, the mode expander is to interface optical signals between the lens and a waveguide of the PLC. In one embodiment, the mirror comprises a total internal reflection surface processed in the mode expander. In one embodiment, the total internal reflection surface is processed on the mode expander via laser ablation. In one embodiment, optical circuit further includes alignment marks processed on a planar surface of the substrate, the alignment marks including structures extending from the planar surface for alignment of the optical coupler.

In one aspect, a system includes an optical coupler including a planar substrate having two planar surfaces, one on each opposing side of the substrate, the substrate transparent to a target wavelength; a lens array processed on one of the planar surfaces of the substrate, the lens array including multiple lenses; a mode expander processed on the other planar surface of the substrate; and multiple mirrors coupled to the mode expander, each mirror lithographically aligned with a corresponding lens to exchange an optical signal of the target wavelength between the mode expander and the lens; and an optical connector having an array of single-mode optical fibers coupled to the optical coupler, where each optical fiber interfaces with one of the lenses of the array.

In one embodiment, the planar substrate comprises a glass substrate prepared for processing on both sides of the glass. In one embodiment, the mode expander is to interface optical signals between the lens and a waveguide of the PLC. In one embodiment, the mirror comprises a total internal reflection surface processed in the mode expander. In one embodiment, the total internal reflection surface is processed on the mode expander via laser ablation. In one embodiment, the system further includes alignment marks processed on a planar surface of the substrate, the alignment marks including structures extending from the planar surface for alignment of the optical coupler.

In one aspect, a method comprising: processing a lens on one planar surface of a two-sided substrate, the substrate optically transparent to a target wavelength; processing a mode expander on the other planar surface of the substrate; processing a mirror on the mode expander to exchange an optical signal of the target wavelength through the substrate between the mode expander and the lens; and lithographically setting the mode expander to align the mirror with the lens.

In one embodiment, processing the mode expander includes performing reflow processing to connect the mode expander to the substrate. In one embodiment, the method further includes performing adhesive bonding to a planar lightwave circuit (PLC).

Flow diagrams as illustrated herein provide examples of sequences of various process actions. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. An optical connector comprising:
a planar substrate having two planar surfaces, one on each opposing side of the substrate, the substrate transparent to a target wavelength;
a lens processed on one of the planar surfaces of the substrate;
a mode expander processed on the other planar surface of the substrate; and
a mirror coupled to the mode expander, the mirror lithographically aligned with the lens to exchange an optical signal of the target wavelength between the mode expander and the lens.

2. The optical connector of claim 1, wherein the planar substrate comprises a glass substrate prepared for processing on both sides of the glass.

3. The optical connector of claim 1, wherein the planar surface to which the mode expander is processed includes a processing artifact cavity in the planar substrate adjacent the mirror.

4. The optical connector of claim 1, wherein the mode expander is to interface optical signals between the lens and a waveguide of an optical circuit.

5. The optical connector of claim 1, wherein the mirror comprises a total internal reflection surface processed in the mode expander.

6. The optical connector of claim 5, wherein the total internal reflection surface is processed on the mode expander via laser ablation.

7. The optical connector of claim 5, wherein the total internal reflection surface is processed on the mode expander via grayscale processing.

8. The optical connector of claim 1, further comprising:
alignment marks processed on a planar surface of the substrate, the alignment marks including structures extending from the planar surface for alignment of the optical connector.

9. The optical connector of claim 1, further comprising:
kinematic alignment structures processed on a planar surface of the substrate.

10. An optical circuit comprising:
an optical coupler including
a planar substrate having two planar surfaces, one on each opposing side of the substrate, the substrate transparent to a target wavelength;
a lens processed on one of the planar surfaces of the substrate;
a mode expander processed on the other planar surface of the substrate; and
a mirror coupled to the mode expander, the mirror lithographically aligned with the lens to exchange an optical signal of the target wavelength between the mode expander and the lens; and
a planar lightwave circuit (PLC) coupled to the mode expander to exchange optical signals between the lens and an optical processing circuit.

11. The optical circuit of claim 10, wherein the planar substrate comprises a glass substrate prepared for processing on both sides of the glass.

12. The optical circuit of claim 10, wherein the mode expander is to interface optical signals between the lens and a waveguide of the PLC.

13. The optical circuit of claim 10, wherein the mirror comprises a total internal reflection surface processed in the mode expander.

14. The optical circuit of claim 13, wherein the total internal reflection surface is processed on the mode expander via laser ablation.

15. The optical circuit of claim 10, further comprising:
alignment marks processed on a planar surface of the substrate, the alignment marks including structures extending from the planar surface for alignment of the optical coupler.

16. A system comprising:
an optical coupler including
a planar substrate having two planar surfaces, one on each opposing side of the substrate, the substrate transparent to a target wavelength;
a lens array processed on one of the planar surfaces of the substrate, the lens array including multiple lenses;
a mode expander processed on the other planar surface of the substrate; and
multiple mirrors coupled to the mode expander, each mirror lithographically aligned with a corresponding lens to exchange an optical signal of the target wavelength between the mode expander and the lens; and
an optical connector having an array of single-mode optical fibers coupled to the optical coupler, where each optical fiber interfaces with one of the lenses of the array.

17. The system of claim 16, wherein the planar substrate comprises a glass substrate prepared for processing on both sides of the glass.

18. The system of claim 16, wherein the mode expander is to interface optical signals between the lens and a waveguide of the PLC.

19. The system of claim 16, wherein the mirror comprises a total internal reflection surface processed in the mode expander.

20. The system of claim 19, wherein the total internal reflection surface is processed on the mode expander via laser ablation.

21. The system of claim 16, further comprising:
alignment marks processed on a planar surface of the substrate, the alignment marks including structures extending from the planar surface for alignment of the optical coupler.

22. A method comprising:
processing a lens on one planar surface of a two-sided substrate, the substrate optically transparent to a target wavelength;
processing a mode expander on the other planar surface of the substrate;
processing a mirror on the mode expander to exchange an optical signal of the target wavelength through the substrate between the mode expander and the lens; and
lithographically setting the mode expander to align the mirror with the lens.

23. The method of claim 22, wherein processing the mode expander further comprises:
performing reflow processing to connect the mode expander to the substrate.

24. The method of claim 22, further comprising:
performing adhesive bonding to a planar lightwave circuit (PLC).
